(19) United States
(12) Patent Application Publication
(10) Pub. No.: US 2006/0289599 A1
(43) Pub. Date: Dec. 28, 2006

(54) Staple leg-bending mechanism

(75) Inventor: Nobuaki Yagi, Tokyo (JP)

Correspondence Address: MORGAN LEWIS & BOCKIUS LLP, 1111 PENNSYLVANIA AVENUE NW, WASHINGTON, DC, 20004, US

(73) Assignee: MAX CO., LTD., Tokyo (JP)

(21) Appl. No.: 10/566,575

(22) PCT Filed: Jul. 29, 2004
(86) PCT No.: PCT/JP04/11190

§ 371 Date: Jan. 31, 2006

(30) Foreign Application Priority Data
Aug. 1, 2003 (JP) 2003-285301

(51) Int. Cl. B25C 7/00

(52) U.S. Cl. 227/154

(57) ABSTRACT

A staple formed in the C-shape is inserted from an obverse side of the sheets of paper into the sheets of paper by a driver that moves in the thickness direction of the sheets of paper to be stapled; and a pair of clinchers 23, 24 held rotatably by clincher 21, 22 holders so as to be opposed to the staple with the sheets of paper between are rotated by a clincher actuating member 27 that moves in cooperation with the movement of the driver, so that both legs of the staple, after piercing the sheets of paper, are bent along a reverse side of the sheets of paper in parallel. Further, the height Hl of the clincher 23, 24 in the clincher actuating member moving direction is made smaller than the height H2 of the clincher holder 21, 22.

### TECHNICAL FIELD

The present invention relates to a staple legs bending mechanism for binding sheets of paper to be stapled together at a desired position.

### BACKGROUND ART

Conventionally, a copying machine stack tray provided with an electric stapler that binds copied sheets together at a desired position has been known (for example, JP-A-2002-052482).

FIG. 5 is a front view of a main portion showing a main structure of a clincher drive mechanism in such the electric stapler. In FIG. 5, reference numeral 1 is an electric stapler, reference numeral 2 is a magazine, reference numeral 3 is a clincher base, reference numeral 4 is a clincher, reference numeral 5 is a clincher actuating member, reference numeral 6 is a driving cam, and reference numeral 7 is sheets of paper to be stapled, which are an object to be bound.

The electric stapler 1 includes, in addition to the shown mechanisms, a control unit, a drive motor, and other mechanisms, the main mechanism for driving the clincher is shown in FIG. 5.

The magazine 2 includes a cartridge 10 which accommodates many staple coupling bodies 9 in a stacking state (in an up-and-down direction of the figure), in which each staple coupling body 9 is formed in a shape of a sheet by connecting many straight wire staples 8 (in a depth direction of the figure); a forming plate 11 having a downward concave shape, Which bends both legs of the staple 8 from the upside to the downside, while the stapler coupling body 9 is fed out from the cartridge 10 by thickness of one staple 8 at a time; an anvil 12 which supports a central lower surface of the staple 8 so as to bend the staple 8 in cooperation with the forming plate 11; and a driver 13 having the downward convex shape, which drives the bent staple 8 in the sheets of paper to be stapled 7.

The staple coupling body 9 is formed by gluing about one hundred wire-shaped staples 8 together in parallel so that they can be separated one by one by the driver 13.

Inside the cartridge 10, the many staple coupling bodies 9 can be housed in a stacking state. Further, from the lower portion of the cartridge 10, the staple coupling body 9 can be fed out to the side in the depth direction of the figure.

Each of the forming plate 11 and the driver 13 is formed of a plate-shaped member having a substantially the same thickness as the thickness of the staple 8. Further, the forming plate 11 and the driver 13 are arranged in a state superimposed back and forth so that the driver 13 is located on the surface side of the figure, and they move up and down integrally. Further, the forming plate 11 includes a pair of leg portions 11a for forming the staple 8 supported by the anvil 12 in the downward C-shape. The C-shaped staple includes a straight upper portion (center portion) and both legs extending perpendicularly from both ends of the upper portion.

When the forming plate 11 is forming the both sides of a staple 8 on the anvil 12 in the C-shape, the driver 13 drives the staple 8 that has been already formed in the C-shape by the forming plate 11 and the anvil 12, in the sheets of paper to be stapled 7. Namely, when the driver 13 inserts the staple 8 formed in the C-shape into the sheets of paper to be stapled 7, a next wire-shaped staple 8 to be driven is formed in the C-shape.

Namely, when forming and driving are completed by the driver 13 and the forming plate 11, and they move from a bottom dead center position to a top dead center position, the staple 8 formed in the C-shape by the forming plate 11 is pressed together with the stapler coupling body 9 by not-shown pushers located on both sides of the anvil 12, and comes into contact with a stopper (not shown) forming a front wall of a staple driving path.

Next, when the driver 13 and the forming plate 11 retreat upward of the staple 8, the staple 8 formed in the C-shape, in a state where its center portion is coupled to the staple coupling body 9, is brought into contact with a stopper plate.

As the driver 13 and the forming plate 11 further descend, the staple 8 formed in the C-shape is pressed by the driver 13 and separated from the staple coupling body 9, the both legs of the staple 8 begins to pierce the sheets of paper to be stapled 7, and both legs of the next staple 8 sequent to this staple 8 begins to be formed in the C-shape by the forming plate 11.

When the driver 13 completely inserts the rectangular staple 8 into the sheets of paper to be stapled 7, the forming plate 11, by forming both legs of the next staple 8, completes to form the next staple 8 in the C-shape.

When the driver 13 drives the staple 8 into the sheets of paper to be stapled 7, upper surfaces (leading end portions opposed to each other) of the clinchers 4, 4 face downward, which is different from the shown state.

The clincher base 3 is held movably up and down in relation to a not-shown chassis forholdingthemagazine2. The clincher base 3 is driven by a drive mechanism and a control unit which are provided for the chassis of the electric stapler.

The drive mechanism of the electric stapler is composed of a motor and a gear mechanism which are not shown, and the control unit is composed of a microcomputer and a peripheral circuit connected to the microcomputer.

Further, in a vicinity of the clincher base 3 of the electric stapler, a sensor for detecting setting of the sheets of paper to be stapled 7 is provided. This sensor is composed of, for example, a microswitch and an optical sensor. When the sensor detects that the sheets of paper to be stapled 7 have put on a table 3a of the clincher base, it actuates the drive mechanism through the control unit, and causes the clincher base 3 to ascend, whereby the sheets of paper to be stapled 7 is held between the clincher base 3 and the magazine 2.

The thickness of the sheets of paper 7 inserted between the table 3aof the clincher base 3 and the magazine 2 is previously set to the thickness of which sheets of paper 7 can be fastened together by the staple 8. As a sensor for judging whether the sheets of paper 7 of a thickness can be fastened with the staple 8 or not, for example, a microswitch is provided in a moving area of the clincher base 3.

For example, in the area where the clincher base 3 ascends when the sheets of paper 7 to be stapled are put between the clincher base 3 and the magazine 2, the microswitch that sets an upper limit value of the thickness of the sheets of paper 7 to be stapled is arranged. When the microswitch detects that the thickness of the sheets of paper 7 exceeds the upper limit value, it transmits its detection signal to the control unit.

In case of the thickness of the sheets of paper 7 that cannot be fastened together with the staple 8, for example, a sensor for detecting the moving amount of the clincher base 3 detects that fastening is impossible and outputs its detection to the control unit. The control unit prohibits the driver 13 from driving the staple 8, causes the clincher base 3 to descend thereby to release the sheets of paper 7, and displays no-fastening in a display unit such as a liquid crystal display.

Both sides of a front end portion of the clincher base 3 into which the sheets of paper to be fastened 7 are inserted are formed respectively by a nearly L-shaped side plate portion 14 integrally. To the back side of the front end portion of the clincher base 3, a clincher holder 16 is attached, which supports rotatably the clincher 4 through a shaft 15.

In the table 3a, an opening portion 3b from which a leading end 4a of this clincher 4 can protrude toward the sheets of paper 7 side is provided. This opening portion 3b permits the leading end 4a of each clincher 4 to protrude in order to bend the both legs of the staple 8 along the reverse side of the sheets of paper to be stapled 7 in parallel.

This clincher 4 is usually urged downward by energy of a not-shown coil spring.

The clincher actuating members 5 are supported pivotally by the left and right side plate portions 14 of the clincher base 3. Further, at a lower endportion of the clincher actuating member 5, a cam plate portion 5a is formed, which is bent at a right angle to the clincher actuating member 5 and inserted into a recess portion 4b of the clincher 4. Further, with an upper portion of the clincher actuating member 5, a contact shaft 6a protruding from the driving cam 6 comes into contact.

The driving cam 6 rotates by rotation of the gear mechanism that drives by the drive of the motor, and the contact shaft 6a rotates the clincher actuating member 6, whereby the cam plate portion 5a moves downward and the leading end 4a of the clincher 4 rises. In cooperation with this rising, the both legs of the staple 8 are bent along the reverse side of the sheets of paper to be stapled 7 in parallel in the position where the leading end 4a protrudes from the opening portion 3b to the sheets of paper 7 side, whereby binding of the sheets of paper to be stapled 7 is completed.

In the thus constructed electric stapler, when the leading end 4a of the clincher 4 that faces usually downward fastens the sheets of paper 7 together with the staple 8, the leading end 4a of the clincher 4 protrudes from the opening portion 3b in order to bend the both legs of the staple 8 along the reverse side of the sheets of paper 7 in parallel.

Therefore, when the leading ends 4a of the clinchers 4 bend the both legs of the staple 8 along the reverse side of the sheets of paper 7 in parallel, the leading ends 4a of the clinchers 4 protrude from the opening portions 3b, whereby such a problem is caused that the leading ends 4a of the clinchers 4 come into contact with the reverse side of the sheets of paper 7 and the sheets of paper 7 become dirty by the leading ends 4a.

### DISCLOSURE OF THE INVENTION

An object of the invention is, in order to solve the above problem, to provide a staple legs bending mechanism which can prevent dirt on the reverse side of the sheets of paper to be stapled.

A staple legs bending mechanism of the invention includes a driver which moves a staple formed in the C-shape in the thickness direction of sheets of paper to be stapled and drives the staple into the sheets of paper from an obverse side of the sheets of paper; a pair of clinchers which are held rotatably by clincher holders so as to be opposed to the staple with the sheets of paper between, and a clincher actuating member which moves in cooperation with movement of the driver and rotates the clincher so as to bend, after both legs of the staple have pierced the sheets of paper to be stapled, the both legs along a reverse side of the sheets of paper in parallel. Herein, the height of the clincher in the moving direction of the clincher actuating member is made smaller than the height of the clincher holder, and the clincher is so constructed as not to protrude from the clincher holder to a side of the sheets of paper when the clincher bends the legs of the staple along the reverse side of the sheets of paper in parallel.

### BRIEF DESCRIPTION OF THE DRAWINGS

FIG. 1 is a front view of a clincher portion of an electric stapler according to a first embodiment of the invention.

FIG. 2A is a front view of the clincher portion of the electric stapler of the invention, showing a state before sheets of paper to be stapled are fastened together,

FIG. 2B is a front view of the clincher portion of the electric stapler of the invention, showing a state where the sheets of paper to be stapled are bound.

FIG. 3A is an exploded perspective view of the clincher portion of the electric stapler of the invention,

FIG. 3B is a perspective view of the clincher portion of the electric stapler of the invention.

FIG. 4 is a front view of a clincher portion of an electric stapler in a second embodiment of the invention.

FIG. 5 is a front view of a main portion of a conventional electric stapler.

In the drawings, reference numeral 8 represents a staple, reference numeral 13 represents a driver, reference numeral 21 represents a clincher holder, reference numeral 22 represents a clincher holder, reference numeral 23 represents a clincher, reference numeral 24 represents a clincher, and reference numeral 27 represents a clincher actuating member.

### BEST MODE FOR CARRYING OUT THE INVENTION

### First Embodiment

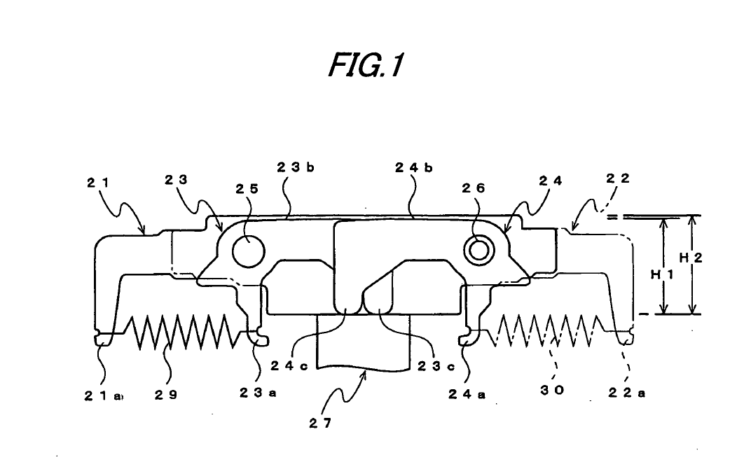

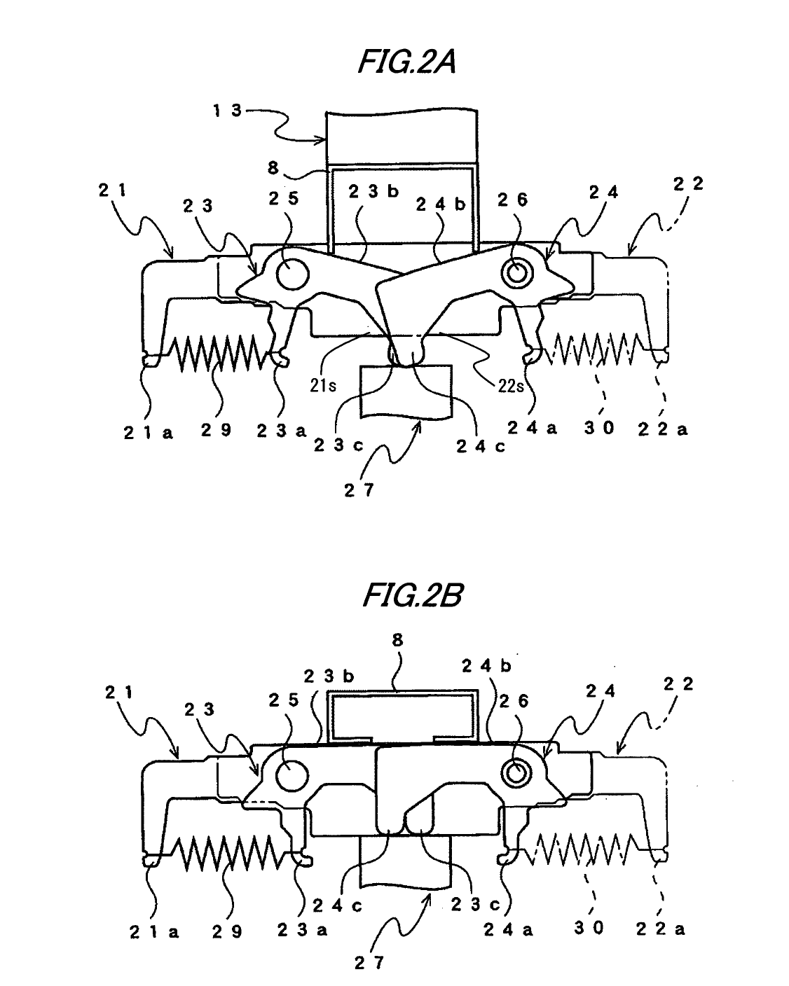

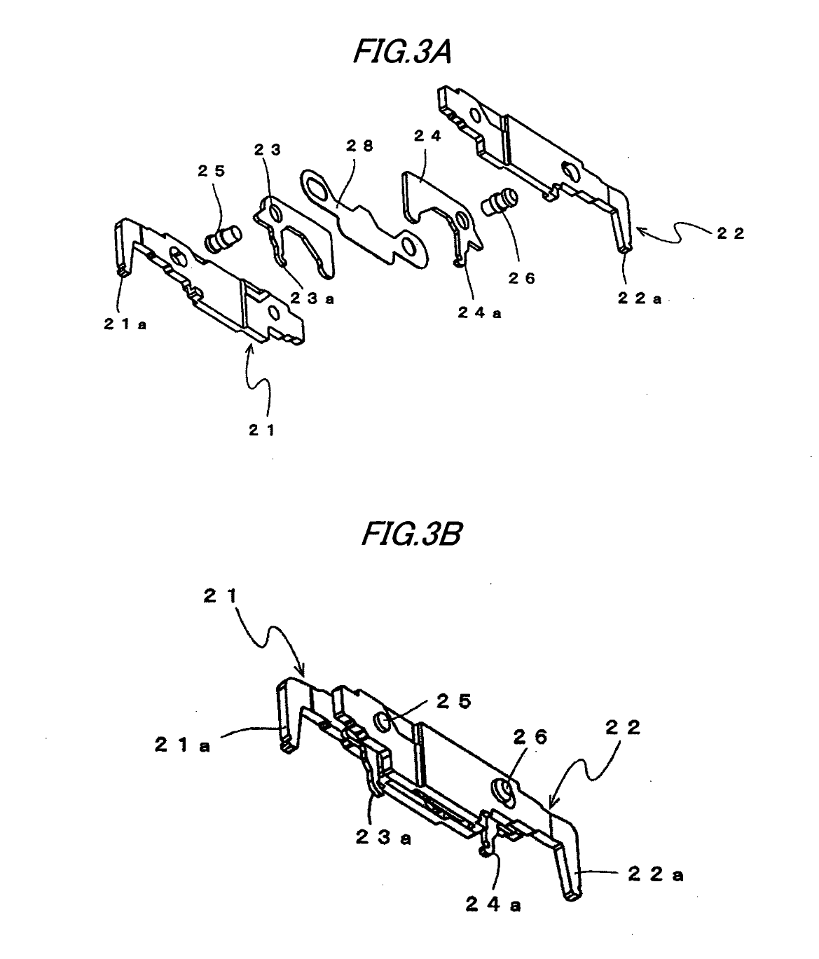

FIG. 1 is a front view of a clincher portion of an electric stapler, FIG. 2A is a front view of the clincher portion of the electric stapler in a state before sheets of paper to be stapled are fastened together, FIG. 2B is a front view of the clincher portion of the electric stapler in a state where the sheets of paper to be stapled are bound, FIG. 3A is an exploded perspective view of the clincher portion of the electric stapler, and FIG. 3B is a perspective view of the clincher portion of the electric stapler.

FIGS. 1, 3A, and 3B, reference numerals 21 and 22 are a pair of clincher holders, reference numerals 23 and 24 are a pair of clinchers, each of which is held movably through each shaft 25, 26 by each clincher holder 21, 22, and reference numeral 27 is a clincher actuating member.

The clincher holders 21 and 22 are held through a clincher base to a chassis for holding a not-shown magazine. Further, at the end portion of each clincher holder 21, 22, a leg portion 21a, 22a is formed integrally with the clincher holder. Between the clincher holders 21 and 22, the clinchers 23 and 24 are assembled so as to be gripped through the shaft 25, 26 by the clincher holders.

Between the clinchers 23 and 24, a thin spacer 28 (refer to FIG. 3A) is laid. Therefore, slidableness of the clinchers 23 and 24 are secured. Further, the clinchers 23 and 24 have integrally leg portions 23a and 24a. Between the leg portion 23a, 24a and the leg portion 21a, 22a, each coil spring 29, 30 is laid. By energy of the coil springs 29 and 30, as shown in FIG. 2A, forming surfaces 23b and 24b face usually downward in the direction where they come close to each other. Further, the clinchers 23 and 24 have integrally tongue pieces 23c and 24c that come into contact with the clincher actuating member 27.

At this time, as shown in FIG. 1, the height of the clincher 23, 24 in the moving direction of the clincher actuating member 27, that is, the height Hi between the forming surface 23b, 24b and the end surface of the tongue piece 23c, 24c is made smaller than the height H2 of the main body of the clincher holder 21, 22 (H1<H2). Therefore, as shown in FIG. 2B, when the both legs of the staple 8 are bent along the reverse side of the sheets of paper to be stapled (not shown) in parallel, the forming surfaces 23b and 24b of the clinchers 23 and 24 do not protrude from the clincher holders 21 and 22 to a side of the sheets of paper.

Further, stoppers 21s and 22s for regulating the rotational movement of the clinchers 23 and 24 caused by rising of the clincher actuating member 27 may be provided for the clincher holders 21 and 22. In this case, when the clincher actuating member 27 moves to a top dead center position (to a state shown in FIG. 2B), the leading end (upper end in the drawing) of the clincher actuating member 27 comes into contact with the stoppers 21s and 22s of the clincher holders 21 and 22, whereby more rotational movement of the clinchers 23 and 24 is stopped more surely.

Under the above configuration, the both legs of the staple 8 formed nearly in the C-shape pierce the sheets of paper to be stapled by means of the driver 13 that descends upon reception of starting of a not-shown drive mechanism.

Next, by the clincher actuating member 27 that ascends in cooperation with the descent of the driver 13, the clinchers 23, 24 move rotationally with each shaft 25, 26 as a support. Hereby, the both legs of the staple 8 that have pierced the sheets of paper to be stapled are gradually bent by the forming surfaces 23b and 24b so as to come close to each other. The ascent of the clincher actuating member 27, as shown in FIG. 2B, stops when the both legs of the staple 8 have been bent along the reverse side of the sheets of paper (when the clincher actuating member 27 achieves the top dead center).

At this time, since the height H1 of the clincher 23, 24 is smaller than the height H2 of the clincher holder 21, 22 (H1<H2), the forming surfaces 23b and 24b do not come into contact with the reverse side of the sheets of paper. Therefore, it is prevented that the reverse side of the sheets of paper becomes dirty by the clinchers 23, 24 due to bending of the both legs of the staple 8.

### Second Embodiment

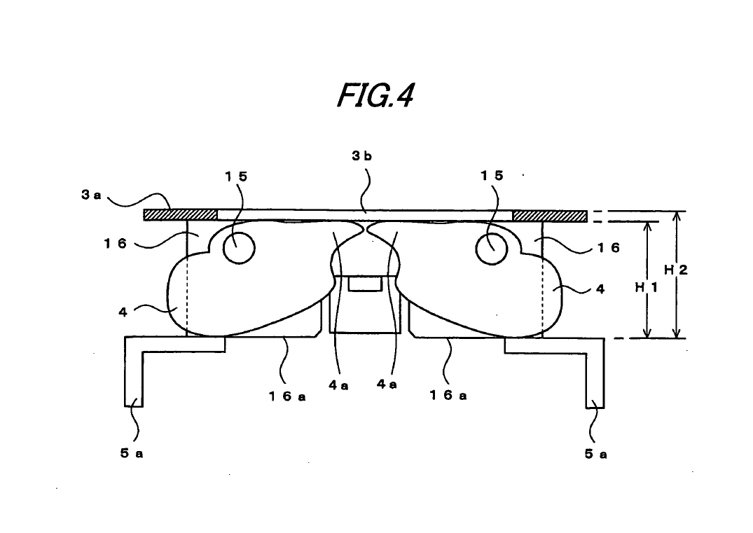

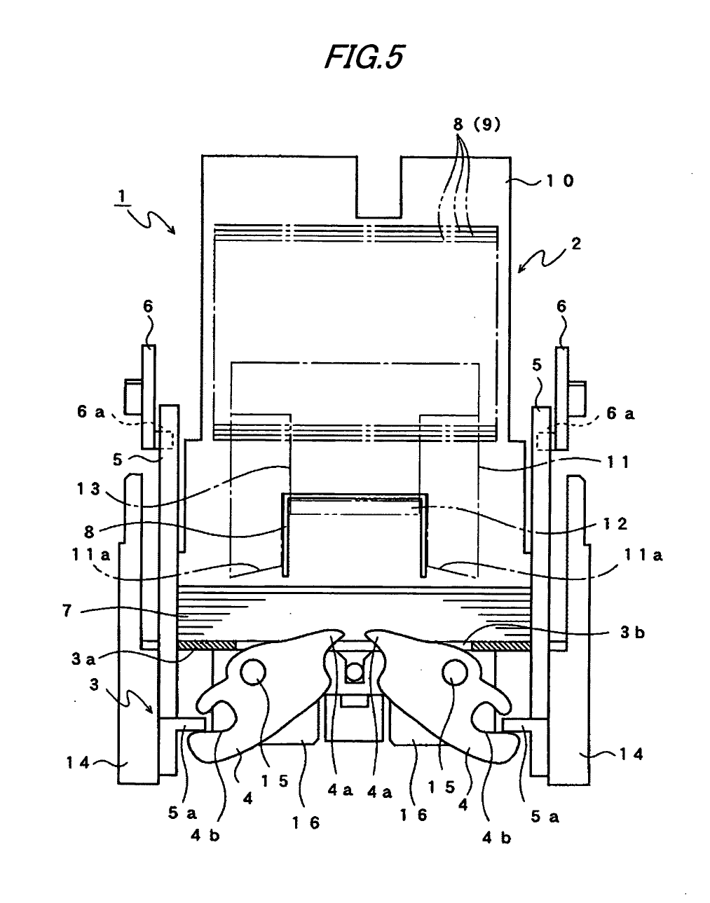

In the above first embodiment, the clincher actuating member 27 is composed of one block-shaped member similarly to the driver 13. However, as shown in FIG. 4, the clincher actuating member 27 may be composed of a pair of cam plate portions 5a, of which each corresponds to each clincher 4. In this case, the height H1 of this clincher 4 is made smaller than the height H2 (that may include practically the thickness of a table 3a in this example) of the clincher holder 16, whereby the same advantage as that in the first embodiment can be expected.

Further, also in this case, by bringing the cam plate portion 5a into contact with a bottom surface 16a of a clincher holder 16, more ascent of the cam plate portion 5a is stopped. Hereby, it is also possible to prevent the clincher 4 from rotating more in the ascent direction.

### INDUSTRIAL APPLICABILITY

In the staple legs bending mechanism of the invention, the staple formed in the C-shape is inserted from the obverse side of the sheets of paper into the sheets of paper by the driver that moves in the thickness direction of the sheets of paper to be stapled; and a pair of clinchers held rotatably by the clincher holders so as to be opposed to the staple with the sheets of paper between is rotated by the clincher actuating member that moves in cooperation with the movement of the driver, so that the both legs of the staple, after piercing the sheets of paper, are bent along the reverse side of the sheets of paper in parallel. Further, the height of the clincher in the clincher actuating member moving direction is smaller than the height of the clincher holder. Therefore, when the clinchers bend the both legs of the staple along the reverse side of the sheets of paper in parallel, the clinchers do not protrude from the clincher holders to a side of the sheets of paper, so that it is prevented that the dirt of the reverse side of the sheets of paper to be stapled is produced.

Further, by the contact of the clincher actuating member with the clincher holder, the more rotational movement of the clincher is stopped. Therefore, when the clinchers bend the both legs of the staple along the reverse side of the sheets of paper in parallel, the protrusion of the clinchers from the clincher holders to the side of sheets of paper can be more surely prevented.

1. A staple legs bending mechanism comprising:
a driver that moves a staple formed in the C-shape in a thickness direction of sheets of paper to be stapled and drives both legs of the staple into the sheets of paper from an obverse side of the sheets of paper;
a clincher holder arranged on a reverse side of the sheets of paper to be stapled;
a pair of clinchers, rotatably held by the clincher holder, for bending the both legs of the staple along the back surface of the sheets of paper to be stapled by a rotational movement; and
a clincher actuating member that moves in cooperation with a movement of the driver and rotates the clinchers, wherein a height of the clinchers in a moving direction of the clincher actuating member is smaller than a height of the clincher holder, so as to prevent the clincher from protruding from the clincher holder to the paper side when the both legs of the staple are bent along the back surface of the sheets of paper.

2. The staple legs bending mechanism according to claim 1, further comprising:
a stopper that is formed on the clincher holder and comes into contact with the clincher actuating member.

3. The staple legs bending mechanism according to claim 1, wherein the height of the clincher holder includes a thickness of a table.

4. The staple legs bending mechanism according to claim 1, wherein the clincher actuating member includes a block-shaped member.

5. The staple legs bending mechanism according to claim 1, wherein the clincher actuating member comprises a pair of cam members respectively provided for the pair of clinchers.
